(19) United States
(12) Patent Application Publication
(10) Pub. No.: US 2005/0266309 A1
(43) Pub. Date: Dec. 1, 2005

(54) Battery gasket

(75) Inventors: Jon K. West, Gainesville, FL (US); Thomas J. McCall, Ft. White, FL (US); Thomas E. Audit, Alachua, FL (US)

Correspondence Address: MORRISON & FOERSTER LLP, 1650 TYSONS BOULEVARD, SUITE 300, MCLEAN, VA, 22102, US

(73) Assignee: WAVECREST LABORATORIES, Dulles, VA (US)

(21) Appl. No.: 10/853,770

(22) Filed: May 26, 2004

(51) Int. Cl. H01M 2/08; F16J 15/10

(52) U.S. Cl. 429/185; 277/628; 277/650; 429/35

(57) ABSTRACT

The invention relates to a gasket for single or multi-cell rechargeable batteries and provides an improved seal between multiple cells in a battery or between a cell and the vent of a pressure vessel. In particular, the invention illustratively is described as having at least two alternating sectional profiles, each different section being fabricated to permit greater equalization of pressure between cells and the other section fabricated to retain electrolyte within the cell.

### FIELD OF THE INVENTION

The present invention relates to a gasket for use in multi-cell batteries. More particularly, the invention relates to novel design for a sealing member to allow for better pressure equalization and electrolyte containment in individual energy storage cells disposed within a common pressure vessel.

### BACKGROUND OF THE RELATED ARTS

Typically, multi-cell batteries use an o-ring, or similar seal, to contain the electrolyte within each energy storage cell of the battery. Such seals, however, are adequate for containing the electrolyte within the cell at high pressures that occur at the end of charge or during excessive overcharge and for securing and positioning the coil of the energy storage device concentrically within the cell casing. However, for equalization of low differential pressure between cells in a common pressure vessel due to the gassing that occurs during normal charge and discharge of the battery an o-ring does not work.

During charge and discharge, electrolytic cells produce hydrogen gas that must be carefully managed. Such gas is normally absorbed in a chemical reaction by the negative electrode. However, if this reaction fails to work at the same rate that hydrogen is being generated then and only then it must be vented through an outlet on a pressure vessel containing the cells. If not handled properly, the gas can cause the unwanted emission of gas and electrolyte. As well, the energy storage cell may fail to emit excess gas, causing battery failure—sometimes explosively.

O-ring seals of the prior art generally take the form of a flexible, circular member having a generally circular cross-section. Such a seal may be made of a very firm material, to better contain electrolyte, or of a softer material, to better vent gasses at low pressure differentials and to equalize pressure within a multi-cell battery. Due to the cross-section of such o-rings, however, whenever gasses are emitted through the seal, the o-ring must deform. This allows the coil in the cell to shift position and possibly for electrolyte to escape from the cell. If the o-ring seal is made of a material that is firm enough to avoid the unwanted loss of electrolyte, rapid charging or discharging of the battery can cause the battery to explode due to excess gassing. Alternatively, the battery may be made “anode limited” to minimize the current output of the battery, to avoid excess gassing.

To maximize the power output of a battery having at least one, and preferably multiple cells, it is therefore desirable to have a gasket that is capable of equalizing pressure within a multiple cell battery even at low pressure differentials while being able to contain the electrolyte solution within the cell and without allowing the coil to shift position. As well, this gasket should provide these properties without requiring any limitation on the current output of the battery or restrict the charge rate or discharge rate of the energy storage device.

### SUMMARY OF THE INVENTION

In an illustrative embodiment, the invention can be characterized as a gasket configured to be positioned between a first region and a second region in an energy storage device. The gasket may include at least a first rectilinear section configured to prevent movement of electrolyte between the first region and the second region and to permit equalization of pressure between the first region and the second region. The first region and second region may be multiple energy storage devices, or cells, within a multiple cell battery in a common pressure vessel. Alternatively, the first region may be a cell within a single or multiple cell battery and the second region may be a region which vents to the outside of a pressure vessel within which at least one energy storage device is disposed.

In another preferred embodiment, a device in accordance with the present invention may be characterized as a gasket configured to be positioned between a first region and a second region in an energy storage device. The preferred gasket may include at least two zones (which zones may also be referred to as areas, or configurations, or geometries, or structures). The gasket having these two zones is configured to achieve at least three functions. First, at least one of the zones is configured to maintain the gasket in position relative to the energy storage device. Second, at least one of the zones is configured to prevent movement of fluid between the first region and the second region. Third, at least one of the zones is configured to equalize pressure between the first region and the second region.

In another embodiment of the invention, the gasket may be configured to be positioned between a first region and a second region in an energy storage device, and can be characterized as having at least a first rectilinear section configured to prevent movement of electrolyte between the first region and the second region and to permit equalization of pressure between the first region and the second region, and at least a second rectilinear section configured to retain a cell in the energy storage device. The gasket may be further characterized as being configured such that the first rectilinear section is configured to permit equalization of pressure between the first region and the second region where the pressure differential is not greater than about 100 psi, for example. In other preferred embodiments, for example, the pressure differential may be from about 0 to about 100 psi, or from about 0.001 psi to about 10 psi, or about 0.1 psi to about 5 psi.

The invention also relates to a method of making a gasket to be positioned between a first region and a second region in an energy storage device. Illustratively, the method may include the steps of providing a gasket material, and forming the material into a gasket comprising at least a first rectilinear section configured to prevent movement of electrolyte between the first region and the second region and to permit equalization of pressure between the first region and the second region.

In another embodiment, the method of making a gasket to be positioned between a first region and a second region in an energy storage device may include providing a gasket material, and forming the material into a gasket comprising at least a first rectilinear section configured to prevent movement of electrolyte between the first region and the second region and to permit equalization of pressure between the first region and the second region, and at least a second rectilinear section configured to retain a cell in the energy storage device. The method may be further characterized as permitting the first rectilinear section to be configured to permit equalization of pressure between the first region and the second region where the pressure differential is not greater than a few psi.

In another embodiment of the energy storage device of the present invention, the device may include a first region, a second region, and a gasket configured to be positioned between the first region and the second region, the gasket comprising at least a first rectilinear section configured to prevent movement of electrolyte between the first region and the second region and to permit equalization of pressure between the first region and the second region.

The energy storage device may also be characterized as having a first region, a second region, and a gasket configured to be positioned between the first region and the second region, wherein the gasket has at least a first rectilinear section configured to prevent movement of electrolyte between the first region and the second region and to permit equalization of pressure between the first region and the second region, and at least a second rectilinear section configured to retain a cell in the energy storage device. The gasket may have a first rectilinear section that is configured to permit equalization of pressure between the first region and the second region where the pressure differential is not greater than a few psi.

In another exemplary embodiment of the invention, the energy storage device may also have at least one coil associated with at least one of the first region and the second region, the coil comprising an outer diameter and an inner diameter and the outer diameter and the inner diameter defining a ratio of not less than 6 to 1.

The method of making an energy storage device may also be characterized as including the steps of providing a first region, providing a second region, positioning a gasket between the first region and the second region, the gasket having at least a first rectilinear section configured to prevent movement of electrolyte between the first region and the second region and to permit equalization of pressure between the first region and the second region.

In another embodiment of a method of making an energy storage device, the invention may include the steps of providing a first region, providing a second region, and positioning a gasket between the first region and the second region. The gasket may include at least a first rectilinear section configured to prevent movement of electrolyte between the first region and the second region and to permit equalization of pressure between the first region and the second region, and at least a second rectilinear section configured to retain a cell in the energy storage device. Further, the first rectilinear section may be configured to permit equalization of pressure between the first region and the second region where the pressure differential is not greater than a few psi, i.e., not more than about 3 to 4 psi, for example. In an exemplary embodiment, the method contemplates providing at least one coil associated with at least one of the first region and the second region, the coil having an outer diameter and an inner diameter and the outer diameter and the inner diameter defining a ratio of not less than 6 to 1.

In another embodiment, the method may include storing energy in a device comprising a first region, a second region and a gasket disposed between the first region and the second region. The gasket may have at least a first rectilinear section to prevent movement of electrolyte between the first region and the second region, and using the gasket comprising at least a first rectilinear section to permit equalization of pressure between the first region and the second region.

In another illustrative embodiment, the method of the present invention may include storing energy in a device comprising a first region, a second region, and a gasket disposed between the first region and the second region. The gasket may have at least a first rectilinear section and at least a second rectilinear section. The gasket having the at least a first rectilinear section to prevent movement of electrolyte between the first region and the second region is used to permit equalization of pressure between the first region and the second region, and to retain a cell in the energy storage device.

Further, the gasket may be configured to be positioned between a first region and a second region in an energy storage device. The gasket may have a variegated, rectilinear, or any other non-circular section configured to prevent movement of electrolyte between the first region and the second region, to permit equalization of pressure between the first region and the second region, and to retain a cell in the energy storage device, preferably concentrically within the cell casing.

### BRIEF DESCRIPTION OF THE DRAWING FIGURES

FIG. 1 illustrates an embodiment of an energy storage device in a common pressure vessel.

FIG. 2 shows an embodiment of an o-ring for containing electrolyte in a cell of a multi-cell battery with a common pressure vessel.

FIG. 3 illustrates an embodiment of the gasket of the present invention.

FIG. 4 show a common pressure vessel having multiple energy storage cells employing a gasket according to an embodiment of the present invention to contain electrolyte within each cell and to equalize pressure within the vessel.

### DETAILED DESCRIPTION OF THE INVENTION

The present invention relates to an electrical energy storage device. Particularly, the present invention, in one embodiment, can be characterized as gasket with improved properties for retaining electrolyte and equalizing pressure within a pressure vessel housing one or more energy storage devices.

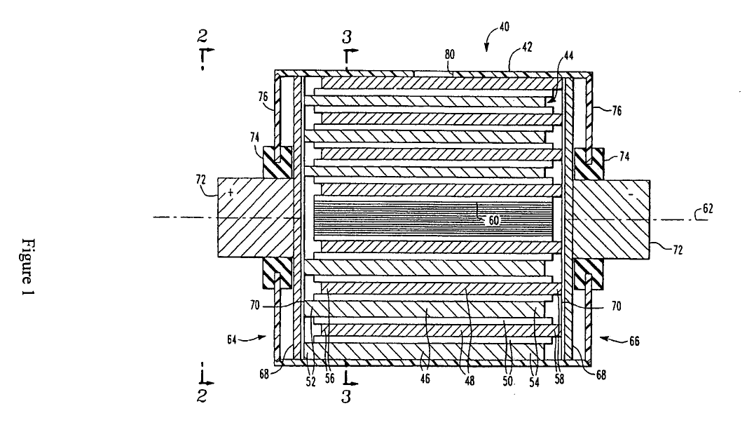

The energy storage cell of the present invention includes a casing. An embodiment of the electrical energy storage device of the present invention is shown in FIG. 1 and is designated generally by reference numeral 40. The storage device 40 includes a tubular casing. The casing 42 is preferably made of a nonconductive material, such as plastic. The casing must also be chemically compatible with the electrochemistry of the storage device, and thus be resistant and impermeable to the electrolyte used. Any such suitable material may be employed as the casing.

The device further includes an energy storage device made up of a coiled winding having a cathode plate including a strip having a pair of elongated side edges, an anode plate including a strip having a pair of elongated side edges, and a separator located between the cathode and anode plates. The storage device 40 includes a coiled winding 44 made of three elongated rectangular strips wound together: a cathode plate 46, an anode plate 48 and a separator 50. The separator 50 is wound between the cathode plate 46 and the anode plate 48 along their entire lengths to prevent the plates from contacting each other. The cathode plate 46 and the anode plate 48 each have two elongated side edges 52 and 54, and 56 and 58, respectively, which extend along the entire lengths of the longest sides of the plates.

Preferably, each of the current collectors comprises a solid member impervious to electrolyte flow therethrough. As shown in FIG. 1 the current collectors 68 are solid members through which no electrolyte may pass. The current collectors 68 include disc-shaped portions extending over the sides of the winding 44. Thus, the current collectors 68 seal the electrolyte in the winding 44. It should be understood that the current collectors 68 may be made of multiple parts attached together, for example, by welding, as long as the electrolyte is kept within the winding 44 by the current collectors.

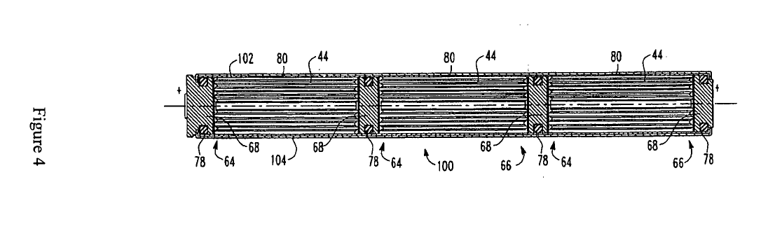

As shown in FIG. 1, the winding 44 and the current collectors 68 may be held within a casing 42 which may be made of polyethylene or any other nonconductive material. Exterior electrical connection may be made directly with the current collectors 68. As also shown in FIG. 1, conductor rods 72 may be provided extending from the current collectors 68 for transmitting energy. Grommets 74 may be disposed around the conductor rods 72 and may be held by discs 76 secured to the casing 42. The discs 76 form a seal with the casing 42 so as to keep electrolyte from leaking out of the winding 44. Similarly, the grommets 74 form a seal with the conductor rods 72 to prevent leakage. Alternately, as shown in FIG. 4, the discs 76 and grommets 74 may be eliminated and a seal member such as a gasket 78 may extend around the current collectors 68 to prevent leakage of electrolyte between the current collectors 68 and casing 42. An exemplary energy storage device and multi-cell battery of the present invention is further described in U.S. Pat. No. 6,265,098, U.S. Pat. No. 5,667,907, U.S. Pat. No. 5,439,488, and U.S. Pat. No. 5,370,711 which are hereby incorporated by reference in their entireties.

As shown in the various figures, a pressure vessel 45, such as a metal tube, may be disposed about the casing 42. The casing 42 and current collectors 68 may be secured within the pressure vessel 45 by crimping the ends of the pressure vessel over the current collectors. The pressure vessel 45 should be able to withstand the vapor pressures generated during the recharging of the device 40, but should have some release mechanism, as described above.

As an alternative to the devices of FIG. 1, only one current collector 68 may be provided for use with a cup-shaped conductive casing or pressure vessel. The end of the winding 44 at the “bottom” of the cup electrically contacts the cup, and the end of the winding at the open end of the cup contacts a current collector 68. The single current collector 68 is secured to the conductive casing with a gasket disposed between the casing and collector to prevent shorting and to seal electrolyte within the casing.

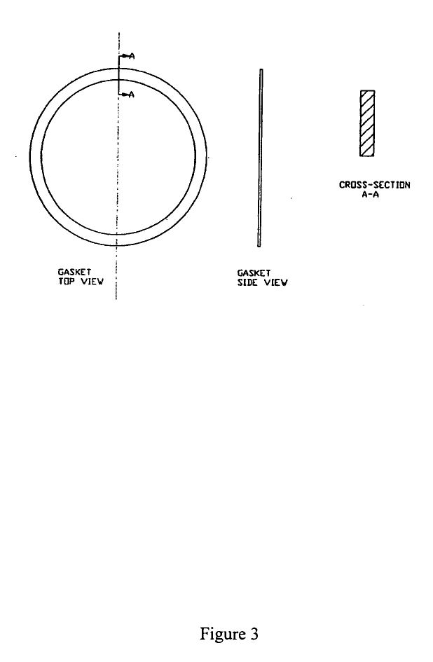

As shown in FIG. 3, a gasket according to the present invention may, in an exemplary embodiment, be described as a generally flat ring having at least two different cross-sectional profiles. The cross-section shown in FIG. 3 and labeled A-A may be of a material that is resistant to degradation by the electrolyte, such as neoprene rubber, although those skilled in the art will recognize that many forms of plastics, rubbers, composites, and other non-conductive materials may be used. The selection of materials for the one or more sections of the gasket may be determined in accordance with the anticipated pressure differential between the first region and second region of the cell.

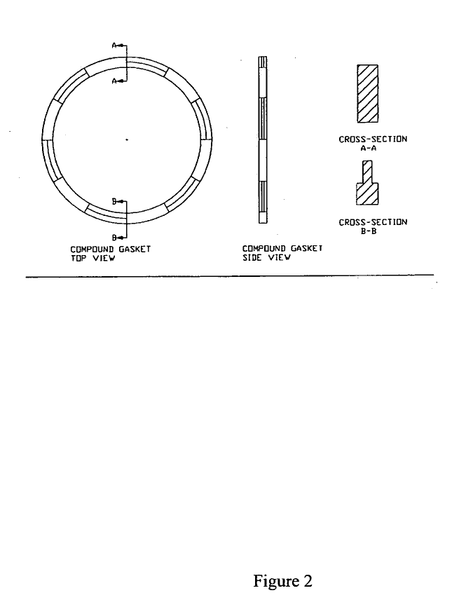

The non-circular section, as shown in FIG. 2, assists in retaining electrolyte within a first region of the energy storage cell of a single or multi-cell battery. When a certain pressure level in the first region is exceeded, the gasket may permit the venting of gas or electrolyte from the first region of the cell into a second region. The second region may comprise, for example, another cell within a common pressure vessel, outside the cell into a pressure vessel, or outside of the cell and the pressure vessel in which the cell is contained, if any.

The section shown and labeled B-B includes a protrusion, narrower that the outer section of the gasket, which permit the escape of gasses from a cell in a battery and to equalize pressure between cells of a multi-cell battery. The material of section B-B may be the same or a different material than that used for the section A-A, although this portion may be made of softer material, to permit the venting of gases at lower pressure differentials, while retaining electrolyte within the cell. In other embodiments of the invention, the may generally be described as having at least one non-circular section, or two or more different sections of the same or different materials.

The invention may also be illustratively described as a gasket configured to be positioned between a first region and a second region in an energy storage device. The gasket may include at least a first rectilinear section configured to prevent movement of electrolyte between the first region and the second region and to permit equalization of pressure between the first region and the second region. The first region and second region may be multiple energy storage devices, or cells, within a multiple cell battery. Alternatively, the first region may be a cell within a single or multiple cell battery and the second region may be a region which vents to the outside of a pressure vessel within which at least one energy storage device is disposed.

The invention may also be described as a gasket which is configured to be positioned between a first region and a second region in an energy storage device, and can be characterized as having at least a first rectilinear section configured to prevent movement of electrolyte between the first region and the second region and to permit equalization of pressure between the first region and the second region, and at least a second rectilinear section configured to retain a cell in the energy storage device. The gasket may be further characterized as being configured such that the first rectilinear section is configured to permit equalization of pressure between the first region and the second region where the pressure differential is not greater than a few psi.

An energy storage device in accordance with the present invention may be used for storing and supplying energy in a variety of different environments and for a variety of different purposes. For example, an energy storage device in accordance with the present invention may be used for storing and supplying energy in transportation vehicles, including for example ground transportation vehicles, air transportation vehicles, water surface transportation vehicles, underwater transportation vehicles, and other transportation vehicles. An energy storage device in accordance with the present invention may be used for storing and supplying energy in communication and entertainment devices, including for example telephones, radios, televisions and other communication and entertainment devices. An energy storage device in accordance with the present invention may be used for storing and supplying energy in home appliances, including for example flashlights, emergency power supplies, and other home appliances. The examples described in this paragraph are merely representative, not definitive.

1. A gasket configured to be positioned between a first region of an energy storage device and a second region, the gasket comprising at least a first section configured to prevent movement of electrolyte between the first region and the second region, to permit equalization of pressure between the first region and the second region, and configured to contain the cell substantially concentrically within a casing or pressure vessel.

2. The gasket according to claim 1, wherein the first section has a non-circular section.

3. The gasket according to claim 2, wherein the first section has a rectilinear, rectangular, square, obloid, ovular, trapezoidal, or forms quadrangular section.

4. The gasket according to claim 3 wherein the first section includes a section having one or more rounded corners.

5. The gasket according to claim 1 having an inner periphery and an outer periphery, the inner periphery including a protrusion.

6. The gasket of claim 5, wherein the protrusion has a substantially rectangular section.

7. The gasket of claim 1 wherein the gasket comprises a non-conductive material.

8. The gasket of claim 7 wherein the gasket comprises a composition selected from the group consisting of rubber, plastic, cellulose fibers, non-conductive alloys, and combinations thereof.

9. A gasket configured to be positioned between a first region of an energy storage device and a second region, the gasket comprising more than one section, wherein each section is configured to prevent movement of electrolyte between the first region and the second region, to permit equalization of pressure between the first region and the second region, configured to contain the cell substantially concentrically within a casing or pressure vessel, or combinations thereof.

10. The gasket according to claim 9, wherein at least one section has a non-circular section.

11. The gasket according to claim 9, wherein at least one section has a rectilinear, rectangular, square, obloid, ovular, trapezoidal, or forms quadrangular section.

12. The gasket according to claim 11 wherein at least one section includes a section having one or more rounded corners.

13. The gasket according to claim 9 having an inner periphery and an outer periphery, the inner periphery including a protrusion.

14. The gasket of claim 13, wherein the protrusion has a substantially rectangular section.

15. The gasket of claim 9 wherein the gasket comprises a non-conductive material.

16. The gasket of claim 15 wherein the gasket comprises a composition selected from the group consisting of rubber, plastic, cellulose fibers, non-conductive alloys, and combinations thereof.

17. The gasket of claims 1 or 9 having at least one section configured to permit equalization of pressure between the first region and the second region where the pressure differential is not greater than 100 psi.

18. The gasket of claim 17 wherein the pressure differential is not greater than 10 psi.

19. The gasket of claim 18 wherein the pressure differential is not greater than 1 psi.

20. The gasket of claim 19 wherein the pressure differential is not greater than 0.1 psi.

21. The gasket of claim 20 wherein the pressure differential is not greater than 0.001 psi.

22. The gasket of claims 1 or 9, wherein the first region comprises a volume within an energy storage device and the second region comprises a volume within second energy storage device and the first region and the second region are within a common pressure vessel.

23. The gasket of claims 1 or 9, wherein the first region comprises a volume within an energy storage device and the second region comprises a volume outside of the first region.

24. An energy storage device, comprising:
a first region,
a second region,
a gasket positioned between the first region and the second region and having more than one section, wherein each section is configured to prevent movement of electrolyte between the first region and the second region, configured to permit equalization of pressure between the first region and the second region, configured to contain the cell substantially concentrically within a casing or pressure vessel, or combinations thereof,
a coil comprising an outer diameter and an inner diameter, wherein the ratio of the diameter of the inner diameter to the outer diameter is not less than 6 to 1.

25. A method of making a gasket to be positioned between a first region and a second region in an energy storage device, the method comprising:
providing at least one type of gasket material, and
forming each type of the gasket material into a gasket comprising at least one section configured to prevent movement of electrolyte between the first region, configured to permit equalization of pressure between the first region and the second region, configured to contain the cell substantially concentrically within a casing or pressure vessel, or combinations thereof.

26. A method of making a gasket to be positioned between a first region and a second region in an energy storage device, the method comprising:
providing a gasket material, and
forming the material into a gasket comprising at least a first rectilinear section configured to prevent movement of electrolyte between the first region and the second region and to permit equalization of pressure between the first region and the second region, and at least a second rectilinear section configured to retain a cell in the energy storage device.

27. The method of claim 26 wherein the first section is configured to permit equalization of pressure between the first region and the second region where the pressure differential is not greater than 100 psi.

28. An energy storage device, comprising:
a first region,
a second region
a gasket configured to be positioned between the first region and the second region, the gasket comprising at least a first section configured to prevent movement of electrolyte between the first region and the second region and to permit equalization of pressure between the first region and the second region.

29. An energy storage device, comprising:
a first region,
a second region
a gasket configured to be positioned between the first region and the second region, the gasket comprising:
at least a first section configured to prevent movement of electrolyte between the first region and the second region and to permit equalization of pressure between the first region and the second region, and
at least a second section configured to retain a cell in the energy storage device.

30. The energy storage device of claim 8 wherein the first section is configured to permit equalization of pressure between the first region and the second region where the pressure differential is not greater than 100 psi.

31. An energy storage device comprising at least one coil associated with at least one of the first region and the second region having a gasket according to claims 1 or 9 therebetween, the coil comprising an outer diameter and an inner diameter and the outer diameter and the inner diameter defining a ratio of not less than 6 to 1.

32. A method of making an energy storage device, comprising:
providing a first region,
providing a second region,
positioning a gasket between the first region and the second region, the gasket comprising at least a first non-circular section and a second non-circular section, wherein each section is configured to prevent movement of electrolyte between the first region and the second region, configured to permit equalization of pressure between the first region and the second region, configured to contain the cell substantially concentrically within a casing or pressure vessel, or combinations thereof, or each section is made from a material configured to prevent movement of electrolyte between the first region and the second region, configured to permit equalization of pressure between the first region and the second region, configured to contain the cell substantially concentrically within a casing or pressure vessel, or combinations thereof.

33. The method of claim 32 wherein the at least one section is configured to permit equalization of pressure between the first region and the second region where the pressure differential is not greater than 100 psi or less than 0.001 psi.

34. The method of 32 comprising providing at least one coil associated with at least one of the first region and the second region, the coil comprising an outer diameter and an inner diameter and the outer diameter and the inner diameter defining a ratio of not less than 6 to 1.

35. A method comprising:
storing energy in a device comprising a first region, a second region and a gasket disposed between the first region and the second region, the gasket comprising at least a first section,
using the gasket comprising at least a first section to prevent movement of electrolyte between the first region and the second region, and
using the gasket comprising at least a first section to permit equalization of pressure between the first region and the second region,
wherein the first section has a non-circular section.

36. A method comprising:
storing or discharging energy via a device comprising a first region, a second region and a gasket disposed between the first region and the second region, the gasket comprising at least a first section having a non-circular section and at least a section having a non-circular section,
using the gasket comprising the first section to prevent movement of electrolyte between the first region and the second region and to permit equalization of pressure between the first region and the second region, and
using the gasket comprising the at least a second section to retain a cell in the energy storage device.

37. A gasket configured to be positioned between a first region and a second region in an energy storage device, the gasket comprising at least one section having a variegated section configured to prevent movement of electrolyte between the first region and the second region, to permit equalization of pressure between the first region and the second region, to retain a cell in the energy storage device, or combinations thereof.

38. A gasket configured to be positioned between a first region and a second region in an energy storage device, the gasket comprising:
at least a first zone and a second zone,
at least one of the first zone or the second zone being configured to maintain the gasket in position relative to the energy storage device,
at least one of the first zone or the second zone being configured to prevent movement of fluid between the first region and the second region, and
at least one of the first zone or the second zone being configured to equalize pressure between the first region and the second region.

39. A method comprising:
providing an energy storage device, the energy storage device comprising a gasket configured to be positioned between a first region and a second region, the gasket comprising at least a first zone and a second zone,
having at least one of the first zone or the second zone maintain the gasket in position relative to the energy storage device,
having at least one of the first zone or the second zone prevent movement of fluid between the first region and the second region, and
having at least one of the first zone or the second zone equalize pressure between the first region and the second region.

40. A device comprising:
an energy storage device, and
means for enabling use of energy stored in the energy storage device,
the energy storage device comprising a gasket configured to be positioned between a first region and a second region, the gasket comprising:
at least a first zone and a second zone,
at least one of the first zone or the second zone being configured to maintain the gasket in position relative to the first region and the second region,
at least one of the first zone or the second zone being configured to prevent movement of fluid between the first region and the second region, and
at least one of the first zone or the second zone being configured to equalize pressure between the first region and the second region.
